(19) United States
(12) Patent Application Publication
(10) Pub. No.: US 2003/0009323 A1
(43) Pub. Date: Jan. 9, 2003

(54) Application platform for developing mono-lingual and multi-lingual systems and generating user presentations

(76) Inventor: Max Adeli, Irvine, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/900,721

(22) Filed: Jul. 6, 2001

(51) Int. Cl. G06F 17/20

(52) U.S. Cl. 704/8

(57) ABSTRACT

A method comprises the steps of obtaining a property setting, from a predefined set of properties; obtaining information comprising process identification, localization identification, and current user identification; using the information with a localization ID to enable access to a data definition table including current process information and current system information; constructing a user presentation; creating a record set object using a business object; creating a painter object with the business object; initializing properties of the painter object and providing the painter set object with the record set object. The method further comprises the steps of insuring the validity of the record set object using the painter object by insuring that the record set object contains a pointer record set component; determining if a menu is required using a process type code obtained in an initialization process; and retrieving a menu definition information from a menu object tables for a target language using the localization ID.

### BACKGROUND OF THE INVENTION

1. Field of the Invention

This invention relates generally to a data processing system having a multi-lingual capability, and more particularly to such a system and method in which a computer program is developed and deployed in a source language and then translated into a target language upon executing the computer program on a computer system.

2. Description of Related Art

The following art defines the present state of this field:

Crabtree, U.S. Pat. No. 4,566,078 describes concurrent multi-lingual use in data processing systems.

Innes, U.S. Pat. No. 4,615,002 describes concurrent multi-lingual use in data processing system.

Andrews et al., U.S. Pat. No. 5,243,519 describes a method and system for language translation within an interactive software application.

Winans, U.S. Pat. No. 5,307,265 describes a computer method and system for communication in a multi-lingual network.

Chalas, U.S. Pat. No. 5,392,386 describes a method and apparatus for adding functionality to computer programs executing under graphical user interfaces.

Chou, U.S. Pat. No. 5,583,761 describes a method for automatic displaying program presentations in different languages.

Thompson et al., U.S. Pat. No. 5,644,775 describes a method and system for facilitating language translation using string-formatting libraries.

Murow et al., U.S. Pat. No. 5,664,206 describes a method and apparatus for automating the localization of a computer program.

Hinks et al., U.S. Pat. No. 5,678,039 describes a system and method for translating software into localized versions.

Hiroya et al., U.S. Pat. No. 5,751,957 describes a communication service system employing translation rules for communicating data in different languages along a network.

McMahon, U.S. Pat. No. 5,787,410 describes a method and apparatus for storing and retrieving data in multiple languages simultaneously using a fully-populated sub-table.

Barnes et al., U.S. Pat. No. 5,974,372 describes a graphical user interface (GUI) language translator.

Herbert, III, U.S. Pat. No. 6,018,742 describes constructing a bifurcated database of context-dependent and context-independent data items.

Hamann, U.S. Pat. No. 6,092,036 describes a multi-lingual data processing system and system and method for translating text used in computer software utilizing an embedded translator.

These references do not teach Lower cost of owner ship (build the business object layer once and use it across all localizations), providing the highest level of customization to the end user by allowing the user to view the result in his/her linguistic preferences, providing capability to design the presentation layer without requiring any access to the source code of the application and therefore allowing to add additional languages to the application without any coding effort in the “business layer” of the application, shortening the development and maintenance phase since the business objects are designed and created with no regard to user presentation layer and therefore, application developers (by far the costliest expense to any software development project) can focus their effort in development and implementation of business rules and requirements, avoiding the need to know about low level and tedious multi-lingual presentation development. All low-level complexity is hidden by the application platform so that the user can concentrate on the development of the business object layer. Further, because of the role-based design of this invention, the security and access authorizations can be implemented across all localizations real time. Since all text, visual, navigation and all other properties required to create the presentation layer is stored separately from the business object components (the programs and codes that define the business) the changes and enhancements to the business components can be easily distributed to the other branches as well as divisions located in other countries. This invention provides a much easier approach for organizations to embrace language independent systems.

### SUMMARY OF THE INVENTION

The present invention teaches certain benefits in construction and use which give rise to the objectives described below.

This invention describes an application platform. An application platform is a piece of server-side software (a server side software is a piece of software that runs on the server computer and communicates with the client computer over wired or wireless networks) that enables vendors to offer integrated and uniform ways to respond to user requests, fetch data from a database, and generate dynamically constructed pages. It could also include an integrated security system. Most application platforms utilize presentation templates in order to produce the presentation layer. A template is a piece of predefined computer language code, usually stored in a flat files or a database tables, that assists in constructing a section or the entire user interface.

Currently one of the most expensive costs to any company is to implement a system across multiple countries and languages. The most common approach to this problem is to acquire a snapshot of the source system and convert all the text attributes and the visual properties of the snapshot version to the target language. From this point forward the systems will grow independently of each other and therefore any fix and enhancement, both to business logic as well as the presentation, must be done completely separate of each other resulting in redundant effort. This requires a lot of time and resources, both financial as well as human, and over time becomes unmanageable.

This invention raises the bar in capabilities provided by the most commonly used application platforms. It does this by introducing hierarchal data definition components by which the members of the information technology department as well as the end users can easily define a given system down to the smallest element (e.g. an objects heading, an objects location, etc). Using the configuration tool provided by this application platform they have the capability to design the presentation layer (FIG. 2—16) without needing access to the source code of the application and thus allowing them to add additional languages to the application without any coding effort in the “business layer” of the application (FIG. 2—26). This approach enables the application platform to assemble and construct the entire presentation layer regardless of the target language, and therefore enabling the design and implementation of fully multilingual applications in a completely customizable presentation layer with out the need for any computer code modifications.

In order to achieve this result the invention uses a unique method of storing enterprise data. Many enterprise level systems in existence today use hundreds of database tables to store raw data. The stored data varies in type and is considered the building block of all data processing systems. This invention uses a concept of separating all user viewable and modifiable text (e.g. product name, product description, how to guide, user instructions, etc . . . ) from the core table. Using this concept, tables are divided in two (FIG. 1—10 & 12), Table1 contains columns that are not text oriented and are not directly viewable by the user (e.g. codes, counter, flags, etc . . . ) and Table2 contains all columns that could contain text values (e.g. product name, product description, etc . . . ) viewable by the user via the presentation layer. Both Table1 and Table2 include the unique key, either system created or user defined, of the core table (FIG. 1—10). In addition to the unique key of the core table, Table2 will also include, as a part of its primary key, a localization ID. The two tables are then coupled using the unique key of the first table as the common key (e.g. user ID, product ID, branch ID, etc . . . ) thus creating a one-to-many relationship between the two tables.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a block diagram of an advanced database design suited for use in multi-lingual systems;

FIG. 2 is a block diagram of a multi-lingual application platform;

FIG. 3 is a block diagram of an application platform configuration tool of the invention;

FIG. 4 is a flow diagram illustrating a method of creating user presentations in an application platform, according to one embodiment of the present invention;

FIGS. 5, 5A and 5B are a flow diagram illustrating the present invention method;

FIG. 6 is a block diagram illustrating the working of a painter and collector objects of the present invention; and

FIGS. 7 and 8 are views of a monitor screen showing the monitor output of the painter object of the invention.

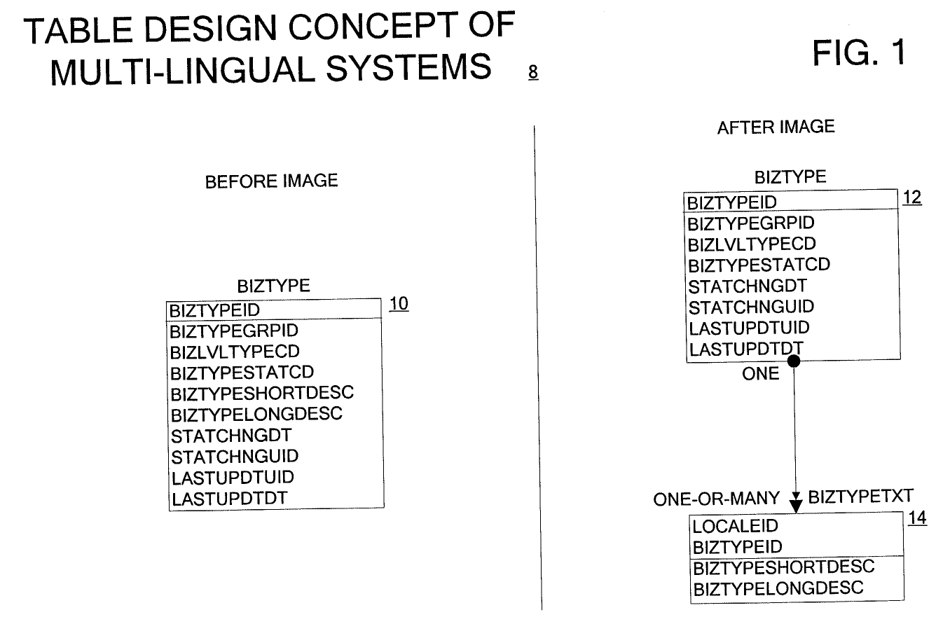

### DETAILED DESCRIPTION OF THE INVENTION

The above described drawing figures illustrate the invention in at least one of its preferred embodiments, which is further defined in detail in the following description. It should be noted that in the following specification and in the claims the items that are expressed in the singular take the plural meaning as well and those expressed in the plural take the singular meaning as well.

A multi-lingual application platform, according to this invention, can allow computer software systems to operate in one or more languages depending upon linguistic preference of the user. The application platform includes computer programs or software that will enable application developers to develop business logic software in a source language and use it across any number of target languages without the need to change the business logic code.

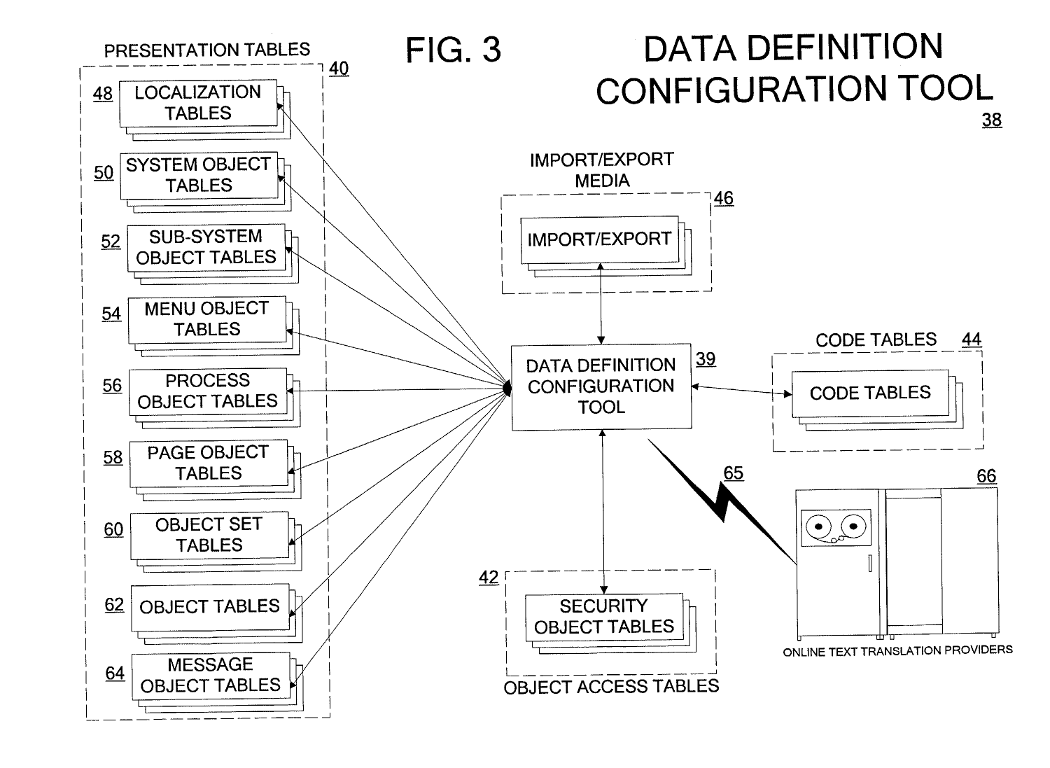

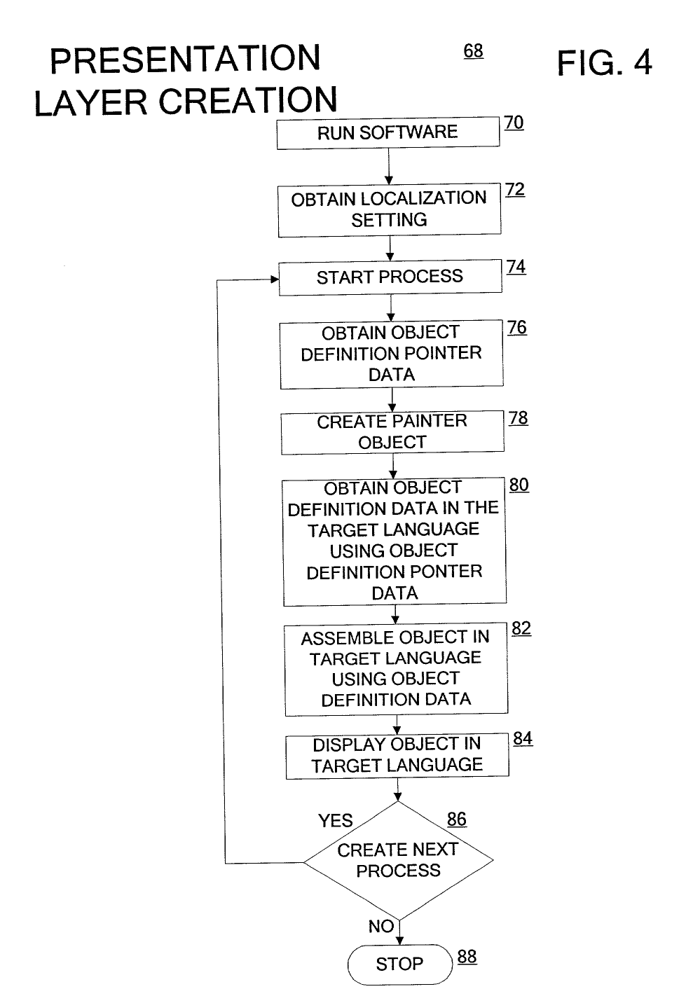

As the application platform runs it obtains one or more property settings, either by the application program or as predefined set of properties. The property settings provide the application platform with information such as process or program identification, localization identification, current user identification, and others. Using the information already obtained and in conjunction with the localization ID, the application platform can obtain further information from the data definition tables (FIG. 3—40). Such information includes and related to the current process, using the process object tables (FIG. 3—56), as well as information on the current system, using the system object tables (FIG. 3—50).

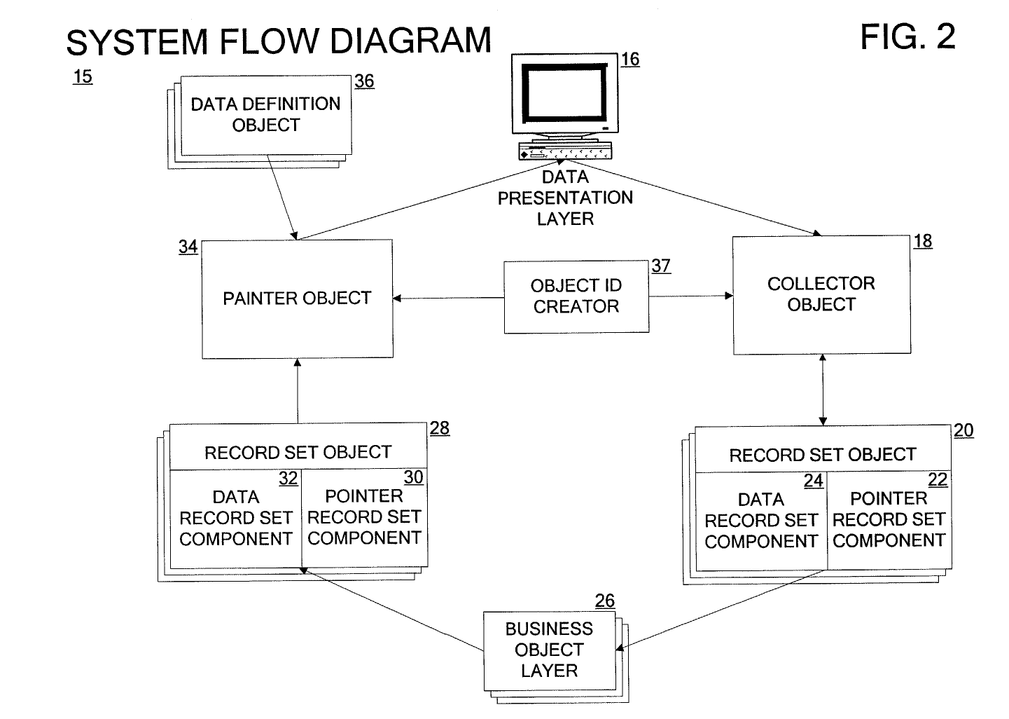

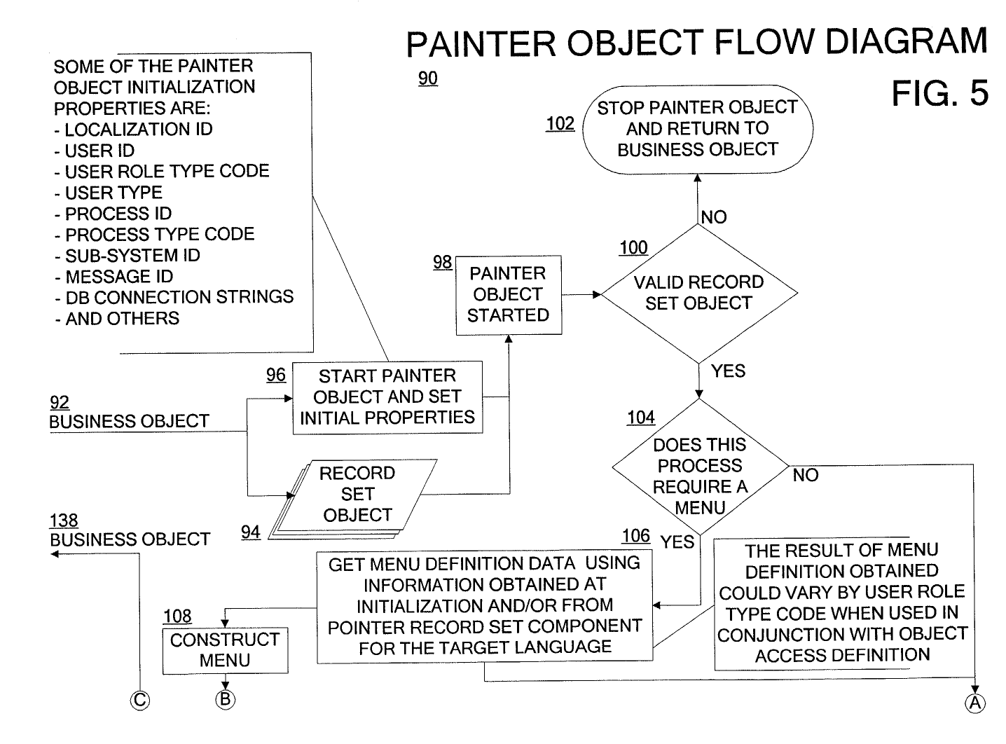

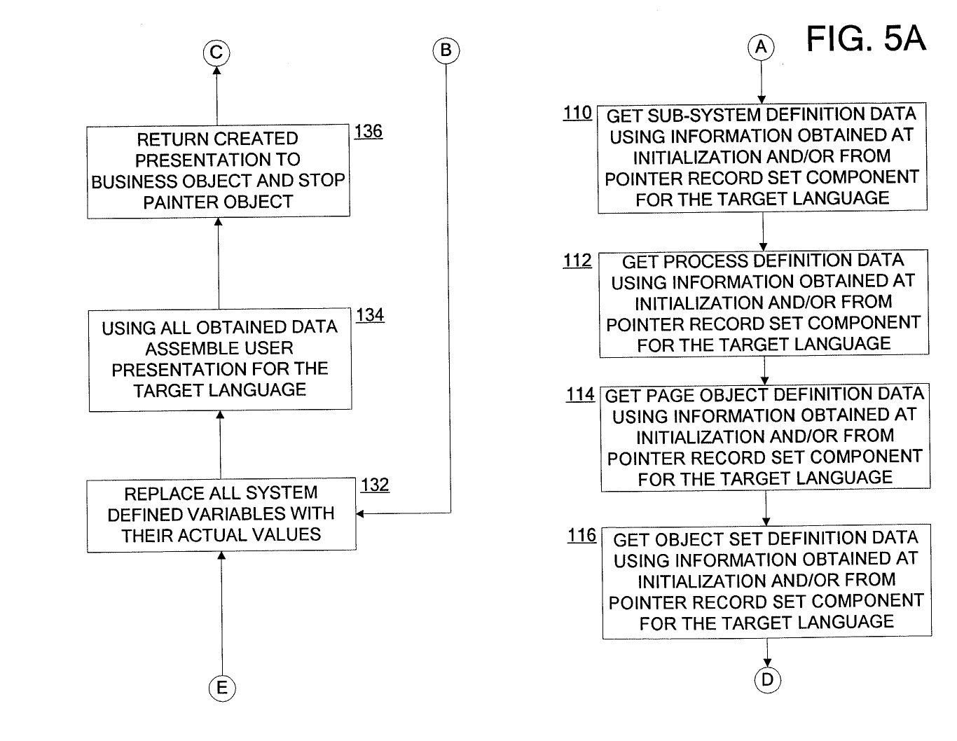

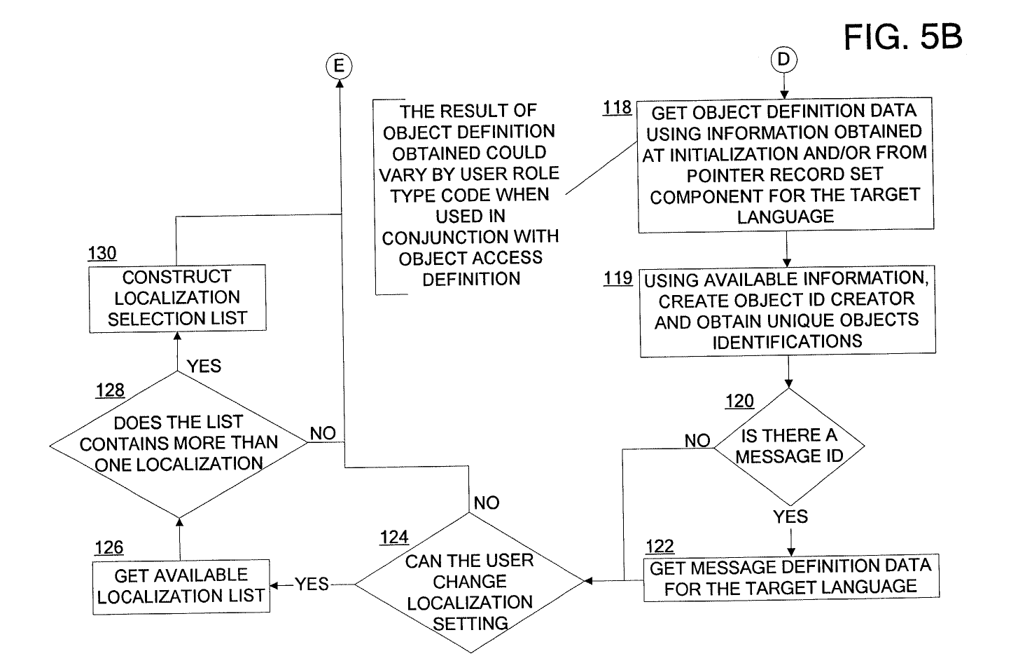

In this invention, in order to assemble and construct the user presentation, the business object is required to create one or more record set objects (FIG. 2—28). Next the business object (FIG. 5—92) will create the painter object (FIG. 2—34) followed by the initialization of the painter object's properties (FIG. 5—96) as well as providing it with one or more record set objects (FIG. 5—94).

The first task of painter object is to insure the validity of the record set object (FIG. 5—100) by insuring that the record set object contains pointer record set component (FIG. 2—30). If a valid record set object, painter object determines whether or not user presentation requires a menu (FIG. 5—104). Painter object accomplishes this by using the process type code obtained as a part of the initialization process (FIG. 5—96). If a menu is required for this process, then the painter object will retrieve the menu definition information (FIG. 5—106) from the menu object tables (FIG. 3—54) for the target language by using the localization ID. In addition to obtaining menu definition information, the painter object will also obtain the user security information by using the user role type code obtained at initialization time (FIG. 3—42). By having available the user security information, the painter object can determine which of the available menu items should be created for the given user, based on the user security and access level (FIG. 5—106). If no menu should be created for this process, then the menu information retrieval and creation step will be bypassed. At this point the painter object begins to obtain sub-system definition data, process definition data, page object definition data, object set definition data, and object definition data (FIG. 3 & 5—40, 110, 112, 114, 116 & 118) for the target language by using the localization ID. Furthermore, the painter object will also obtain the appropriate security information based on the user role type code (FIG. 5—118) and by using the object access definition tables (FIG. 3—42). By having available the user security information, the painter object can determine which of the available objects should be created for the given user based on the user security and access level (FIG. 5—118). Using this information, the painter object creates the object ID creator and provides it with the necessary information in order to create unique identifications for every user editable object (FIG. 5—119) due to be created on the user presentation. The painter object will also determine if a message text need to be shown as a part of the user presentation. This determination is done using the message ID obtained at the initialization process (FIG. 5—96). If a message text is required, then the painter object will obtain the message information (FIG. 5—122) from the message object tables (FIG. 3—64) and for the target language by using the localization ID. If no message should be created for this process, then the message information retrieval and creation step will be bypassed.

The painter object determines if the users are allowed to change the default localization (FIG. 5—124). If so, the painter object will check for the number of available localizations for this sub-system (FIG. 5—126). By this is meant, how many different languages are available for the user presentations of this sub-system. It should be kept in mind that under this application platform a system can be comprised of many sub-systems, such as account payable sub-system, account receivable sub-system, payroll sub-system and so on. If the answer to the number of available localizations is one (FIG. 5—128), then there is no need for creating the list box and allowing the localization selection, since there is only one available.

By design and to improve flexibility, according to this invention, it is not required for all sys-systems to be available in all localizations, for example, account payable can be available to be viewed in English and German where account receivable can be viewed in English, German and French. After determining the number of available localizations, the painter object assembles and constructs a list box containing all available localizations for the target language (FIG. 5—130). If the user is not allowed to change the default localization setting or there is only one localization available, then the localization list box creation step will be bypassed.

At this point the painter object has obtained all the information required to create the user presentation. Therefore, as the first step it will convert all systems define variables to their actual runtime values (FIG. 5—132). Next utilizing all available information, the painter object will assemble and construct the user presentation for every record set object in the target language (FIG. 5—134). This will conclude the task of painter object and therefore, the created user presentation will be returned to the business object.

### Working Association Between Painter and Collector Object

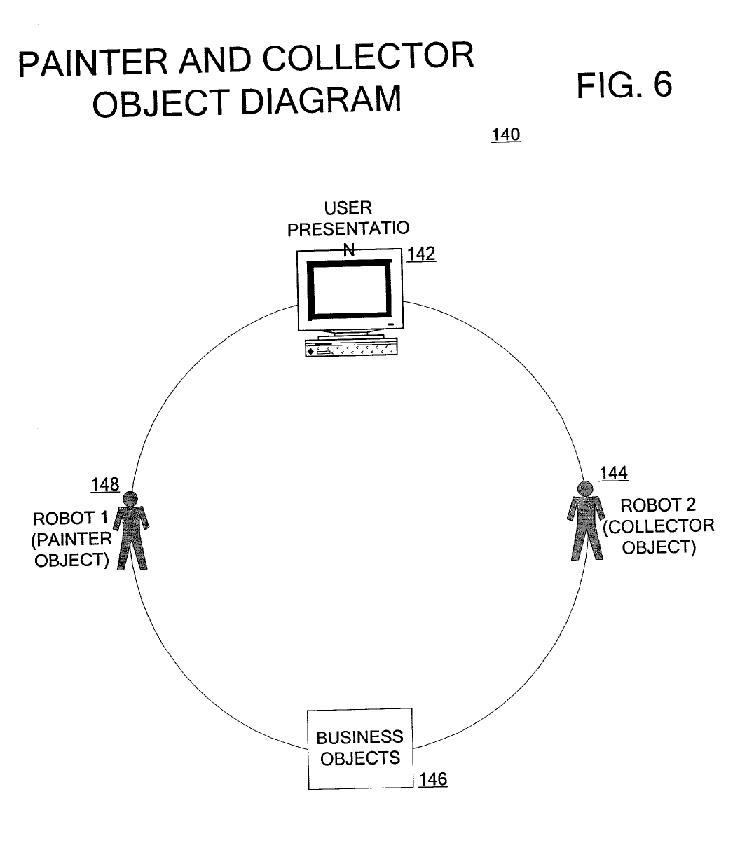

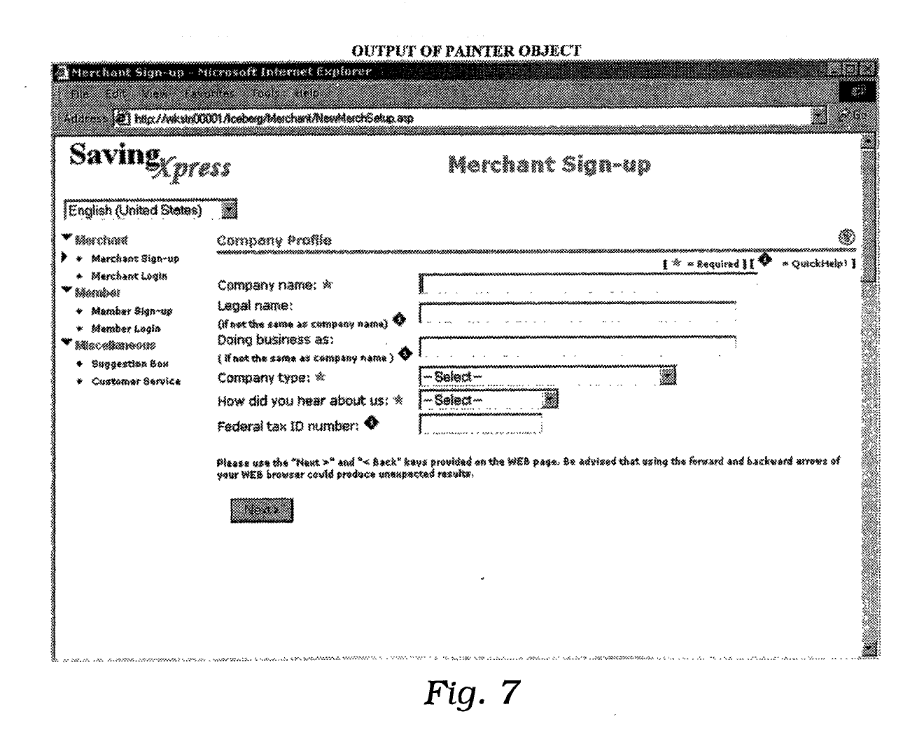

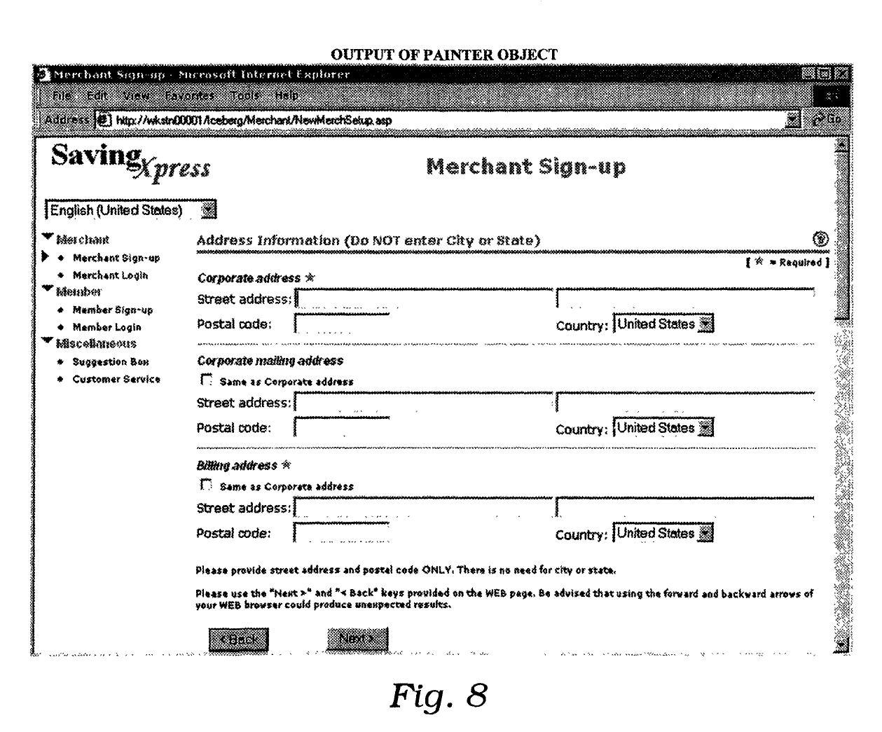

The invention goes further than assembling and constructing user presentation. In order to better illustrate this, the following example is used (FIG. 6—140).

Imagine that we have constructed two robots, robot 1 defines the painter object (FIG. 6—148) and robot 2 defines the collector object (FIG. 6—144). The objective is to minimize the work on the developers in dealings with the user presentation in order to have them focused their effort on developing the business logic (FIG. 6—146), and nothing more. To do this, robot 1 and 2 have been created. Robot 1 (FIG. 6—148) requires receiving one or more record set objects (FIG. 2—28) to server as his instructions. This robot's sole purpose is to create forms, known as user presentation, such as a credit card application form, that a user can understand and therefore be able to complete the form (FIG. 6—142) and return the form to the application software for processing. Robot 2 (FIG. 6—144) requires receiving the form that has been completed as his input and it also needs to use the same record set objects (FIG. 2—20) used by the robot 1 to serve as his instructions. This robot's purpose is to read forms, such as a credit card application form that was completed by a user, and transfer its content to the record set objects and make the record set objects available for processing by the business object. Doing so, we have removed all interactions required by the developer in order to extract the data from the form that was completed by the user. Therefore, the output of the business object is the record set objects delivered to the robot 1, which is required to created the form (FIG. 3—28) and the input to the business object is the record set objects used by the robot 2 and populated with the user provided data (FIG. 3 —20), as part of the data record set component, and ready to be processed.

### Components and Features of the Application Platform

The following is a list of some of the major components of this invention:

Data presentation layer: The data presentation layer (FIG. 2—16) is the communication vehicle for servers to talk to users where the users can provide the server with data required in order to conduct its business operation. The presentation layer could also apply to any screen or monitor attached to a wired or wireless devices, components that export structured data for printing, email, FAXES or to communicate with other applications using wired or wireless networks.

Data definition object: The data definition object (FIG. 2—36) defines the attributes and properties as well as security rights of every object, in a hierarchal fashion, that participates in the creation of the data presentation layer. These attributes and properties can be stored as normalize or none normalize in databases or other data storable media such as but not limited to, XML documents (Extensible Markup Language, defined by W3C, is be used to represent all kinds of data, an XML-document is inherently free-structured, XML supports Unicode), flat files, memory resident objects and others. It also encompasses a comprehensive configuration tool (FIG. 3—38) for creating, maintaining and administrating objects of different levels within the object hierarchy. The configuration tool also provide the ability to directly maintain the text and definition properties of various objects with in the system, as well as, the ability for importing and exporting (FIG. 3—46) object text and definitions to and from other databases, XML documents, flat files, etc . . . Furthermore, the configuration tool described here will allow the members of the application platform administration team to connect to text translation provides (FIG. 3—66) for the baseline creation of the target language.

Object ID creator: Object ID creator (FIG. 2—37) is one of the unique features of this invention. In order to further automate the data presentation (FIG. 2—16) and data gathering process (FIG. 2—18) when the user enters or modifies the data presented on the data presentation layer and notifies the system to initiate processing, by pressing a key on the keyboard or clicking a mouse button or by any other means of initiating an input process, the collector object (FIG. 2—18) accesses the object ID creator process and provides it with information available in the pointer record set component of the (FIG. 2—22) record set object. The object ID creator can then successfully construct the same exact set of object IDs that it constructed once before for the painter object (FIG. 2—34). Using the constructed object IDs the collector object can gather the user data provided by the interaction of the user with the data presentation layer without any need for additional business object layer application coding.

Business object layer: The business object layer (FIG. 2—26) is the functional core of the application that performs calculations, edits, and manipulations of temporary data and can access the databases and other sources of data to accomplish this task.

Record set object: The record set object (FIG. 2—20 & 28) defines the data not yet prepared and packaged for viewing by the end user. The record set object consists of two subcomponents as follows: pointer record set component (FIG. 2—22 & 30) contains information required by the painter object to assemble and construct the data presentation layer as well as collector object to gather the data provided by the user, data record set components: (FIG. 2—24 & 32) consists of the user viewable information without regards to how it should be presented. The content of data record set component is derived from the numerous sources, such as but not limited to, the data provided by the user in the prior sessions, the data provided by the application system, etc.

The record set object is used in two ways, first as an input to painter object (FIG. 2—28) where the user presentation layer, such as the screen viewed by the user, is created, and second as an input/output to the collector object (FIG. 2—20) where the user input is collected and stored in the data record set component (FIG. 2—24) for further processing and validation using business objects (FIG. 2—26).

Painter object: The painter object (FIG. 2—34) is responsible for assembling and constructing the presentation layer in the target language, such as the screen. It is also the component of the application that controls the way the data is wrapped and presented. This task is accomplished using the following two components:

The data provided using the data record set component (FIG. 2—32) of the record set object.

The attributes and properties that are retrieved from the data definition object using the information provided via the pointer record set component (FIG.2—30) of the record set object.

The data definition object (FIG. 2—36) will provide the painter object (FIG. 2—34) with information or ways to obtain the information required for creating the presentation layer (FIG. 3—40).

The following is a list of the information that is provided to the painter object:

Information required by the object ID creator in order to construct a distinguishable object ID by using preparatory algorithm (FIG. 2—37).

The presentation style (FIG. 3—58) such as freeform, tabular, grid, stripped, etc.

Information regarding the character set (FIG. 3—48) and character encoding, such as ISO standard character sets, UTF-8, UTF-16, UTF-32, etc.

Presentation action (FIG. 3—58) or behavior, such as “Cancel” and “Ok” buttons for update type presentation, “Back” and “Next” for wizard type presentation, etc.

General system level attributes (FIG. 3—50) such as company name, database connection strings for supporting distributed databases, IP addresses, server port numbers, application system and application system work directories, location and name of system related images as well as all their coordinates in respect to the presentation layer.

Security information (FIG. 3—42) down to the object level, based on the user role type in order to authorize creation of user viewable object, etc.

Exact coordinates (FIG. 3—40) of every user viewable object.

Message information (FIG. 3—64) such as message text, the type of the message (e.g. Security access error, business process error, business process warning, business process information, system broadcast message, et . . . ) and whether or not to log the message, etc.

User navigation properties (FIG. 3—54) and the coordinates of the user menus as well as menus background color, font attributes, related images, etc.

Screen background color and font attributes as well as related images (FIG. 3—52).

Screen title, title coordinates, title background color and image as well as font attributes (FIG. 3—56 & 56).

object presentation style (e.g. single line edit, drop down list, command button, etc.), object label and/or header, object font attributes as well as the exact coordinates of the object and their size (FIG. 3—62).

Collector object: Using the record set object (FIG. 2—20) the collector object (FIG. 2—18) can obtain the user entered data from the presentation layer. The common object ID creator (FIG. 2—37) enables the collector object to correctly reference and therefore retrieve the data provided by the user, store them in the data record set component of the record set object (FIG. 2—24), and to make it available for processing by the business object layer (FIG. 2—26).

This invention empowers the application platform administrators to selectively keep portions of the user presentation in the source language such as legal contents, contract, licenses, etc . . .

These documents are usually required to be viewed in their original language independent of the context.

This invention also enables the application platform administrators to imbed system defined variables with the text body of the document. The painter object will translate these systems define variables to their proper values at run time (FIG. 2—34). Such systems define variables, which are composed at runtime, pose a higher demand to the logic of the presentation layer assembly and therefore add to the overall complexity of the application platform. A sample of such system defined variables is as follow:

LocaleId—The current localization id selected or assigned to the user.

UserId—The ID of the current user.

UserRoleCd—The role level security of the current user.

UserTypeCd—The type of the user (e.g. merchant, member, supplier and so on).

ProcessTitle—Title of the currently executing program.

ProcessNm—Name of the currently executing program.

SubSysPrimaryDir—The primary directory used by this sub-system.

UserNm—the name of current user.

This system provides the end user and the application platform administrators with different ways of selecting an end user localization parameter as follows:

Dynamic manual selection: The dynamic manual selection allows the user to provide his/her localization preference and therefore over write the system default setting.

Static manual selection: The static manual selection will allow the user to select his/her user localization preference in such way that the selected localization will become his/her default localization setting from that point forward.

System assigned selection: The system assigned selection will allow the members of the application platform administration team to select a default localization setting that it is not modifiable by the end user.

There are different types of changes that can be made to any application. The most important and frequent occur when content data is added, changed or deleted. The comprehensive configuration tool provided with this application platform contains the needed principles to keep its linguistic behavior extensible yet consistent. It provides configuration tool with writing access to all linguistic resources of the application that are subject to the necessary translation process, both manual as well as online which uses online translation providers for creating the baseline of the target language.

Language management is a part of normal maintenance activity of this application platform. The language management occurs when a language is added, made available, disabled, or deleted. The language management is maintaining a set of available languages when content data added, changed, or deleted from the source (primary) language. When changes occur translations are required for all available languages. At this time all newly added or changed content is tagged and accessible to the application platform administrators before the complete set of transactions is made available to the painter object (FIG. 2—34). This principle creates the controlled environment required by this type of process and is provided by the configuration tool made available with this application platform. The tagging provides the mechanism to mark incomplete content data, prevent this data from usage, and to guide the administrators the need for content translation and/or verification. If huge amount of content is added or changed the configuration tool make it available to change the status of a language to “Unavailable”.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for creating a user presentation comprising the steps of: obtaining a property setting; creating a record set object and a painter object; initializing properties of the painter object and providing the painter object with the record set object; using the information and a localization ID to enable access to a data definition table; and constructing a user presentation.

2. The method of claim 1 further comprising the step of: insuring the validity of the record set object using the painter object, by insuring that the record set object contains a pointer record set component.

3. The method of claim 1 further comprising the steps of: determining if a menu is required using a process type code obtained in an initialization process; and retrieving a menu definition information from a menu object table for a target language using the localization ID.

4. The method of claim 1 further comprising the step of: obtaining user security information using a user role type code.

5. The method of claim 4 further comprising the step of: selecting a menu item based upon a user access level.

6. The method of claim 1 further comprising the step of: obtaining a sub-system definition data, process definition data, page object definition data, object set definition data, and object definition data for a target language.

7. The method of claim 4 further comprising the steps of: determining at least one object to be created based on the user access level;

8. The method of claim 7 further comprising the step of: creating an object ID creator; and creating a user editable object identification for user presentation.

9. The method of claim 1 further comprising the step of: determining if a message text is needed using the message ID.

10. The method of claim 9 further comprising the steps of: obtaining the message information from the message object tables using the localization ID.

11. The method of claim 1 further comprising the steps of: determining if a change in default localization is allowed; and assembling a list box of available localizations for plural target languages.

12. The method of claim 1 further comprising the steps of: converting all system defined variables to runtime values; and assembling the user presentation for each record set object in the target language.
